(19) United States
(12) Patent Application Publication
(10) Pub. No.: US 2017/0070433 A1
(43) Pub. Date: Mar. 9, 2017

(54) 5-WAY TCP OPTIMIZATION

(71) Applicants: Dennis Vadura, Trabuco Canyon, CA (US); Wei Kang Tsai, Irvine, CA (US)

(72) Inventors: Dennis Vadura, Trabuco Canyon, CA (US); Wei Kang Tsai, Irvine, CA (US)

(73) Assignee: Badu Networks, Inc., Irvine, CA (US)

(21) Appl. No.: 15/289,055

(22) Filed: Oct. 7, 2016

Related U.S. Application Data
(62) Division of application No. 14/278,418, filed on May 15, 2014.

(51) Int. Cl. H04L 12/801; H04W 28/02; H04L 29/06

(52) U.S. Cl. CPC H04L 47/12; H04L 47/193; H04L 69/163; H04W 28/0273; H04W 28/0289; H04W 80/06

(57) ABSTRACT

A system and method optimizes the response speed and/or throughput of TCP sessions for web browsing and large-file applications. TCP sessions may be terminated in a TCP proxy. When a TCP sessions enters a slow-start phase or a fast retransmit phase, the congestion window is creased to above a threshold, or the transmission timer is set above a fixed threshold, or the slow-start threshold is set above a fixed threshold.

### CROSS REFERENCES TO RELATED APPLICATIONS

The present Application claims priority to U.S. Provisional Patent Application No. 61/823,397 filed on May 15, 2013, which is hereby incorporated by reference in its entirety.

### FIELD OF THE INVENTION

The present invention relates in general, to TCP (transmission control protocol), and more particularly, to optimization of TCP for web browsing and large-file applications over a mixed wired/wireless network.

### BACKGROUND OF THE INVENTION

TCP has been the backbone of the Internet protocol (IP) suite for the past 40 years. Due to the success of the Internet, TCP has become an integral and critical part of the online infrastructure worldwide—it is used almost exclusively for digital communications that require reliable transport.

However, TCP was not designed to serve all the current needs. Over the years, many changes have been introduced to enhance its performance and to adapt it to new realities. However, most of these changes are patches—as a result, today's TCP performs poorly under numerous network conditions, and especially conditions prevalent in wireless networks.

A first limitation of TCP is that TCP generates its feedback in an end-to-end manner—that is, no feedback (except ECN, explicit congestion notification) is sent from an intermediate node between the two end points of a TCP session. This design allows deployment of new end devices into a network without modifying the behavior of the intermediate devices between 2 end points. End-to-end feedback causes 2 problems: (1) the impact of a control action is always felt at the controller (the sender) with a delay of one RTT (round trip time), and (2) the controller receives its feedback indication of the network condition on the path with a delay of ½ to one RTT, or more if the bandwidth is asymmetric. Because of these delays, TCP is always in the catch-up mode with the real-time network condition; timely control is practically impossible.

A second limitation of TCP is insufficient feedback information. The feedback indication in TCP is embodied in the form of ACK (acknowledgment) of the received data at the receiver. While this design minimizes the overhead of consuming return-path bandwidth by the feedback mechanism, the lack of detailed feedback indication is at the heart of TCP's performance issues. For example, TCP assumes all packet losses are caused by congestion in the path—TCP drops its transmission rate in response to all perceived congestion. However, not all losses are caused by congestion. For example, over a wireless link, packets could be lost due to random noise. Losses in a wireless link are often caused by radio interference or fading, and they may not persist—reducing the transmission rate in these cases may be unnecessary and undesirable.

Another problem arises if ACKs are lost in the upstream (returning to the sender). When this happens, the sender cannot differentiate between 2 scenarios: (1) loss of downstream (going to the receiver) packets, or (2) loss of ACKs. By design, TCP drops its transmission rate when an ACK loss is combined with a number of circumstances. Since TCP cannot differentiate the 2 scenarios, its drop in rate in scenario (2) is unwarranted and undesirable. This problem is mitigated somewhat if the sender receives a SACK (selective ACK, a TCP option) packet—but this solution requires that a SACK packet makes it to the sender before the controller drops its rate.

The confusion is more pronounced if the path contains a wireless link. Today's small mobile devices are designed to transmit with limited power—the transmit power is reduced to increase battery life. Therefore, it is likely that some ACKs from a mobile device are lost, while all packets sent to the mobile device are delivered. In a mobile carrier network, occurrences of scenario (2) are very likely.

A third limitation of TCP is that different types of TCP connection need to be optimized differently—blind optimization all TCP connections without regard to their types produces a poor user experience. For example, to render a common web page, a browser usually has to fetch 50-100 page elements (or objects) from many different sites, with each fetch requiring a separate TCP connection. The display portion of a page cannot be rendered unless the browser has received most of the objects in the display area. These TCP sessions are often short and carry only a small to moderate amount of data. For the best user experience, it is necessary for these short TCP sessions to have a short completion (response) time. However, for video streaming or large-file applications, many TCP sessions carry a large amount of data—these TCP sessions should be maximized for throughput. However, based on TCP headers, it is impossible to know precisely the type of application and the best way to optimize a TCP session.

Therefore, there is a need to improve TCP performance over a mixed wired/wireless network for different types of application, and different sizes of content.

### BRIEF SUMMARY OF THE INVENTION

A system and method for optimizing TCP performance for web access and large-file applications over a mixed wired/wireless network, called 5W (5 ways), comprises 5 component methods: (1) aggressive transmission (AT), (2) session steering (SS), (3) short-long session differentiation (SLD), (4) group control (GC), and (5) termination location (TL). A TCP session that is optimized by the 5W method is called a 5W-TCP session.

AT (aggressive transmission) is a method to force the congestion control (CC) in TCP to send packets as fast as possible. The AT method is applied by setting the congestion window to above a threshold, or setting the retransmission timer to above a threshold, or setting the slow start threshold to above a threshold, or any partial or full combination of the above.

The AT method may be applied and re-applied at any time during the lifetime of a TCP session. Optionally, after a Fast Retransmit or after a Slow Start is initiated, the AT method may be re-applied. By default, a 5W-TCP session is started by applying the AT method. Optionally, if a TCP session is classified to be long (having a large amount of data to transfer), the AT method is not applied at the start.

Session steering (SS) is a method to ensure that a group of correlated TCP sessions are optimized together. For example, all TCP sessions for rendering a web page may be accelerated together to minimize the overall time to render the web page. The SS method may be embodied with a layer-4 switch to steer all the traffic of a group of correlated TCP sessions to a designated device for optimization.

SLD is a method to differentiate TCP sessions based on the expected amount of data to transfer in a TCP session. A learning algorithm may be employed to increase the accuracy of predicting the duration length (measured in the amount of data to transfer) of a TCP session. The result of the learning algorithm may be used in a SLD classifier-predictor to classify a TCP session based on the TCP header, and to estimate the total number of bytes to transfer in the TCP session.

Optionally, a SLD classifier-predictor uses HTTP (hypertext transfer protocol) headers for making decisions and prediction.

With group control (GC), the same CC (congestion control) policy is applied to all the TCP sessions in a group. TCP sessions are classified into groups of correlated sessions. The definition of correlation is without restrictions. In one definition, all TCP sessions in a group may have a similar amount of data to transfer. In another definition, all TCP sessions in a group may traverse a shared link.

The GC method is a control system (called GC system) with an observation vector. The percentage of TCP sessions in a group experiencing packet losses may be used as an element in the observation vector. If this percentage is high, the GC system may force all TCP sessions in the group to reduce their rates.

TL (Termination Location) is a method to implement TCP termination points. In the 5W system, TCP termination may be implemented together with content caching. A place to terminate a TCP session is a point on the TCP path that separates the path into 2 sides such that the available bandwidths on the 2 sides of the point differ by a large amount, or that the variability of the available bandwidth on one side is much larger than that on the other side.

### BRIEF DESCRIPTION OF THE DRAWINGS

The above and other objects and features in accordance with the present invention will become apparent from the following descriptions of embodiments in conjunction with the accompanying drawings, and in which:

FIG. 1 is a configuration chart showing how a 5W-TCP gateway is deployed to optimize a set of TCP sessions between a group of servers and a group of end-user fixed or mobile devices.

FIG. 2 is a configuration chart showing how a 5W-TCP gateway is realized as a bypass switch, a layer-4 switch, and 2 groups of blade servers.

### DETAILED DESCRIPTION OF EXEMPLARY EMBODIMENTS

A system and method for optimizing TCP performance, called 5W (5 ways), comprises 5 component methods: (1) aggressive transmission (AT), (2) session steering (SS), (3) short-long session differentiation (SLD), (4) group control (GC), and (5) termination location (TL). The 5W system is designed especially for optimizing TCP performance over a mixed wired/wireless network. A TCP session that is optimized by the 5W method is called a 5W-TCP session.

The 5W system is designed to optimize user experience for 2 classes of application: web browsing, and large-file applications. Examples of large-file applications include software download, image or photo upload, video or music streaming, etc. For large-file applications, a critical metric is the speed of file transfer, which directly translates into throughput. For web browsing, a critical metric is the response (or completion) time of web page rendering.

While the 5W system is an integrated system and method, each component method is a separate optimization, which can be separately implemented for its own merits. In many cases, to produce the maximum benefits, it may be necessary to implement at least 3, or even all 5, of the components methods in an integrated manner.

In particular, the methods of AT, SS, and SLD are designed to reduce the response time of web browsing; the methods of GC and TL are designed to increase the throughput of large-file applications. The methods of SLD, SS, and TL are designed to optimize the performance of both web browsing and large-file applications. While AT is designed to optimize the response speed of web browsing, when used in an integrated manner with SS and SLD, it improves the throughput of large-file applications. While TL is specially designed to enhance large-file applications, when used in an integrated manner with SS and SLD, it improves the response speed of web browsing.

Aggressive transmission (AT) is a method to force the congestion control in a 5W-TCP session to send packets as fast as possible. The AT method is applied by setting or resetting certain parameters of a TCP session to specific values, without any further actions. The AT method can be applied and re-applied at any time during the lifetime of a TCP session.

The AT method is applied by setting the congestion window to above a threshold, or setting the retransmission timer to above a threshold, or setting the slow-start threshold to above a threshold, or by a full or partial combination of the above.

By default, a 5W-TCP session is started by applying the AT method. Optionally, after a Fast Retransmit or a Slow Start is initiated, the AT method is re-applied.

Optionally, the AT mode is used in conjunction with a SLD classifier-predictor. If a SLD classifier predicts a 5W-TCP session to be long (having a large amount of data to transfer), the 5W-TCP session will start without applying the AT method.

Session steering (SS) is a method to ensure that a group of correlated 5W-TCP sessions are optimized together for the benefits of an underlying application. For example, all TCP sessions for rendering a web page may be accelerated together to minimize the overall time to render the web page. The SS method may be embodied with a layer-4 switch to steer all the traffic of a group of correlated 5W-TCP sessions to a designated device for optimization. This method is best used in conjunction with GC (group control) and TL (termination location).

Session steering (SS) may also be used to consolidate TCP terminations at one place. In a mobile carrier network, many concurrent TCP sessions could be related to the activities of an individual user, or a group of users in proximity. It is beneficial to terminate these TCP sessions at the same physical device. For example, if a mobile user is browsing a web page, all the TCP sessions related to rendering a web page may be optimized together to produce the best user experience.

Optionally, the SS method is used to enhance caching. In most web acceleration systems, caching is added to reduce the latency of getting data from remote servers. The SS method allows a group of correlated TCP sessions to be terminated at the same physical device. By placing a cache at the same device, the cache hit rate will be higher.

In using SS, the definition of correlated sessions is without restriction and may depend on user applications. In one definition, all the TCP sessions initiated to render a web page are correlated. In another definition, all the TCP sessions started by a mobile or fixed device are correlated.

SLD is a method to differentiate TCP sessions based on the expected length of duration or the expected amount of data to transfer in a TCP session. For short sessions (having a small amount of data to transfer), a preferred performance metric is the session completion (response) time. For long sessions, a preferred performance metric is the average throughput (or goodput). For short sessions, there is no advantage to fine-tune transmission rates—the session may be over before any changes in the transmission rate can impact the throughput. However, it makes sense to exercise rate control if the session is long. Therefore, for short sessions, it makes sense to apply AT from at the start; for long sessions, rate control makes sense and a preferred method is GC.

The SLD method may be embodied in a SLD classifier-predictor that classifies a TCP session based on its TCP header into a short or long session. The classifier-predictor may also predict the total number of bytes that a TCP session needs to transfer.

Optionally, a SLD classifier-predictor uses HTTP (hypertext transfer protocol) headers in making classification or predictions. In one embodiment, the HTTP header of a HTTP/TCP session is extracted and the header is used as the feature vector in a SLD classifier-predictor.

With group control (GC), the same CC (congestion control) policy is applied to all the TCP sessions in a group. By design, the TCP sessions in a group are correlated according to a definition. The definition of correlation is without restrictions. One definition of correlation may be that “the total number of packets to transfer is less than a threshold.” In another definition, all the TCP sessions that traverse a shared link are in the same group.

The GC method is embodied with a GC control system with an observation vector. A observation vector may include the percentage of TCP sessions in the group that is experiencing a similar event, as an element.

For example, the percentage of the TCP sessions in a group having 2 or more duplicate ACKs may be an element in the observation vector. If the percentage is high, the TCP rates in the group might be too high. When this happens, the GC control system may reduce the rates of TCP sessions in the group. On the other hand, if the percentage of the TCP sessions in a group having duplicate ACKs is low, the GC control system may increase the rates of the TCP sessions in the group.

Optionally, all TCP sessions in the same group may traverse a shared link. Optionally, all TCP sessions associated with a single web page may be in the same group. Optionally, all TCP sessions initiated from a single device may be in the same group. Optionally, all TCP sessions from all users within a pico-cell or micro-cell in a mobile carrier network may be in the same group.

TCP termination is a well-known technique to split a TCP session into 2 independent sessions via a proxy; this technique is variously known as TCP splicing, split TCP, or cascaded TCP. TCP termination provides a way to isolate the traffic on the 2 sides of the termination—in the ideal situation, the traffic on one side of the termination does not affect the traffic on the other side, and vice versa.

In the 5W system, TL (termination location) is a method to implement termination points. The TL method does not allow a termination point to become a new bottleneck—that is, the throughput of the termination device must be higher than the available bandwidth in the path. Optionally, TCP termination is employed together with content caching.

In accordance with the TL method, a place to terminate a plurality of TCP sessions is as follows. The termination point separates the path of each of the TCP sessions into 2 sides, such that the available bandwidths on the 2 sides of the point differ by a large amount, or that the variability of the available bandwidth on one side is much smaller or larger than that of the other side.

In accordance with the TL method, a preferred location for TCP termination in a TCP/IP (Internet Protocol) network is at the demarcation between 2 distinct sections of a path. For example, in a mobile carrier network, a good termination point is between the core network and a backhaul network (sometimes known as an access network). Another good termination point is at a base transmission station in a mobile carrier network. A good termination point for home or office networks is between a Wi-Fi wireless router and the fixed broadband link to the Internet.

A weakness of TCP is that the average throughput drops as RTT increases even when there is sufficient bandwidth in the path. Terminating a long-RTT session in the middle of the path may mitigate this problem. Ideally, if a TCP session is terminated exactly at the half-RTT point, its average throughput doubles.

While termination increases the average throughput of a TCP session, it also adds extra latency to the underlying application. Therefore, the decision to terminate a TCP session has to carefully weigh between the throughput and response speed requirements. For most large-file applications, termination usually adds throughput to the underlying application. To benefit web browsing, TCP termination must be implemented with minimal latency overhead. To help compensate the added termination latency, content caching may be added at the termination point.

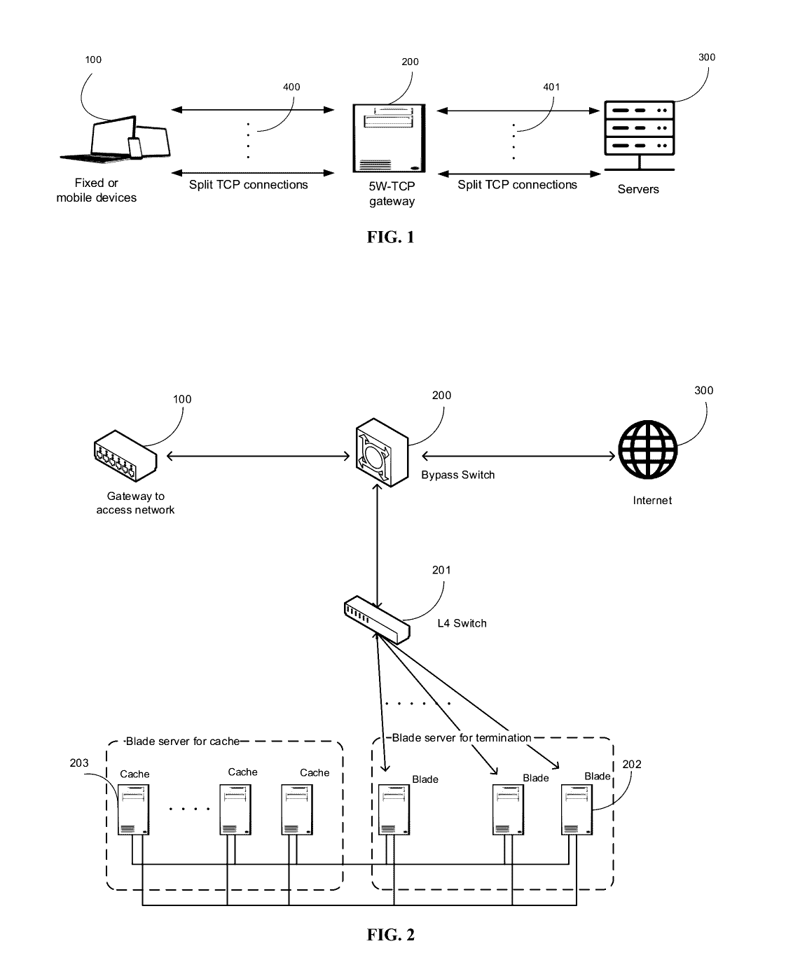

FIG. 1 of the drawing depicts a configuration to deploy a 5W-TCP gateway. In this configuration, a 5W-TCP gateway 200 is placed between a group of end-user fixed/mobile devices 100 and servers 300 on the other side of the Internet. A TCP connection between a fixed/mobile device 100 and a server 300 is broken into 2 separate TCP connections: the first TCP connection 400 from a device 100 to the gateway 200 and the second TCP connection 401 from the gateway 200 to a server 300.

FIG. 2 of the drawing depicts a configuration to deploy a 5W-TCP gateway in a mobile carrier network. A bypass switch 200, a Layer-4 (L4) switch 201, and 2 groups of blade servers 202 and 203 realize the 5W-TCP gateway. Each of the blade servers 202 performs 5W-TCP optimization, including TCP termination, for a plurality of groups of TCP sessions, and each of the blade servers 203 performs content caching to aid the terminated TCP sessions on the blade servers 202. The gateway 100 provides the connection to the access or backhaul network of the carrier network, and the bypass switch connects the TCP sessions to the Internet 300.

What is claimed is:

1. A machine-implemented method to optimize TCP performance in response speed and/or throughput over a network with possibly wireless links, comprising:
placing a TCP termination proxy at a location, which is in the paths of a plurality of TCP sessions, TCP termination being a technology also known as TCP splicing or split TCP;
the TCP termination device performing TCP optimization for each of said plurality of TCP sessions, the method further comprising:
upon a said TCP session entering a slow-start phase or a fast retransmit phase,
(1) setting the congestion window of said TCP session to above a fixed threshold;
(2) or setting the retransmission timer of said TCP session to above a fixed threshold;
(3) or setting the slow-start threshold of said TCP session to above a fixed threshold;
(4) or a partial or full combination of (1), (2), and (3).

2. A machine-implemented method to optimize a TCP session in response speed and/or throughput over a network with possibly wireless links, comprising:
upon said TCP session entering a slow-start phase or a fast retransmit phase,
(1) setting the congestion window of said TCP session to above a fixed threshold;
(2) or setting the retransmission timer of said TCP session to above a fixed threshold;
(3) or setting the slow-start threshold of said TCP session to above a fixed threshold;
(4) or a partial or full combination of (1), (2), and (3).

3. A TCP proxy for optimizing TCP performance in response speed and/or throughput over a network with possibly wireless links, comprising:
at least a processor component;
at least a memory component; and
at least a communications components; wherein the TCP proxy is configured to:
terminate a TCP session between 2 hosts in the TCP proxy, wherein TCP termination is a technology also known as TCP splicing or split TCP;
optimize the TCP session, when said TCP session enters a slow-start phase or a fast retransmit phase, by
(1) setting the congestion window of said TCP session to above a fixed threshold;
(2) or setting the retransmission timer of said TCP session to above a fixed threshold;
(3) or setting the slow-start threshold of said TCP session to above a fixed threshold;
(4) or a partial or full combination of (1), (2), and (3).
